(19) United States
(12) Patent Application Publication
(10) Pub. No.: US 2006/0202991 A1
(43) Pub. Date: Sep. 14, 2006

(54) System and a method for drawing development figures and a computer readable medium thereof

(76) Inventor: Seon Yong Kim, Koyang-Si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/298,557

(22) Filed: Dec. 9, 2005

Related U.S. Application Data
(63) Continuation of application No. PCT/KR04/01439, filed on Jun. 16, 2004.

(30) Foreign Application Priority Data
Jun. 16, 2003 (KR) 10-2003-0038859

(51) Int. Cl. G06T 15/50; G06T 15/60

(52) U.S. Cl. 345/426

(57) ABSTRACT

The present invention provides a system and a method for drawing development figures of a 3-dimensional model automatically and a computer readable program for executing the method.

### RELATED APPLICATIONS

This application is a continuation application under 35 U.S.C. §365 (c) claiming the benefit of the filing date of PCT Application No. PCT/KR2004/001439 designating the United States, filed Jun. 16, 2004. The PCT Application was published in English as WO 2004/111949 on Dec. 23, 2004, and claims the benefit of the earlier filing date of Korean Patent Application No. 10-2003-0038859, filed Jun. 16, 2003. The contents of the Korean Patent Application No. 10-2003-0038859 and the international application No. PCT/KR2004/001439 including its PCT publication are incorporated herein by reference in their entirety.

### FIELD

The present invention relates to a development feature generating system, a development feature generating method and a computer readable medium on which a program for executing the method is recorded. More particularly, the present invention relates to a development feature generating system, a development feature generating method and a computer readable medium on which a program for executing the method is recorded, wherein a 2-dimensional development feature is generated by developing a 3-dimensional image in the method of dividing the entire surface of the 3-dimensional image into a plurality of triangles and converting the 3-dimensional (x, y, z) coordinates into the 2-dimensional (x, y) coordinates for three vertices of each triangle.

### BACKGROUND

In the conventional paper folding, a 3-dimensional shape such as a paper crane, flower, airplane, ship, etc. is formed by repeating folding a flat paper such as a colored paper many times based on a predetermined sequence. Although such conventional paper folding method has been developed in a various way and used widely, there is a manufacturing limit in that a 3-dimensional object is formed by folding a flat paper, and it has not been popularized to the public because of the difficulty of the paper folding.

In addition, there is no way to commercialize the above method other than the book introducing the sequence of paper folding or a paper for paper folding. Meanwhile, there is a method of manufacturing and selling a 2-dimensional development feature so that a user can make a 3-dimensional shape, but it has a limit on accuracy and economical efficiency in terms of time and cost, because the method is restricted to manual work.

### SUMMARY OF THE INVENTION

The present invention has been devised to solve the above problems of the conventional paper folding method, and it relates to a new technology for generating a 2-dimensional development feature, which is guaranteed in terms of accuracy, based on a 3-dimensional image by way of simple operation of a user using a personal computer or other devices.

Accordingly, it is an object of the present invention to provide a system for generating a 2-dimensional development feature based on a 3-dimensional image.

It is another object of the present invention to provide a method for generating a 2-dimensional development feature based on a 3-dimensional image.

It is further another object of the present invention to provide a computer readable medium on which a program for executing the method.

According to this invention, a development feature generating system for generating a development feature of a 3-dimensional object having a predetermined shape includes a 3-dimensional image generating module for generating a 3-dimensional image by modeling the 3-dimensional object, a polygon image generating module for generating a 3-dimensional polygon image by dividing the 3-dimensional image into a plurality of triangles, a first coordinate value converting module for obtaining 3-dimensional coordinate values (x, y, z) for three vertices of a first triangle among the plurality of triangles and converting the 3-dimensional coordinate value of each of the vertices into a 2-dimensional coordinate value (x, y), a second coordinate value converting module for determining a 2-dimensional coordinate value for each vertex of a triangle adjacent to one of three sides of the triangle, in which the 2-dimensional coordinate values for three vertices thereof have been determined, and a flat image representing module for representing the triangles as a 2-dimensional image based on the 2-dimensional coordinate values (x, y) of the first triangle and the 2-dimensional coordinate values (x, y) of the adjacent triangle.

According to this invention, a development feature generating method for generating a development feature of a 3-dimensional object having a predetermined shape includes a 3-dimensional image generating step of generating a 3-dimensional image by modeling the 3-dimensional object, a polygon image generating step of generating a 3-dimensional polygon image by dividing the 3-dimensional image into a plurality of triangles, a first coordinate value converting step of obtaining 3-dimensional coordinate values (x, y, z) for three vertices of a first triangle among the plurality of triangles and converting the 3-dimensional coordinate value of each of the vertices into a 2-dimensional coordinate value (x, y), a second coordinate value converting step of determining a 2-dimensional coordinate value for each vertex of a triangle adjacent to one of three sides of the triangle, in which the 2-dimensional coordinate values for three vertices thereof have been determined, and a flat image representing step of representing the triangles as a 2-dimensional image based on the 2-dimensional coordinate values (x, y) of the first triangle and the 2-dimensional coordinate values (x, y) of the adjacent triangle.

According to this invention, a computer readable medium on which a program for executing the above method is recorded is provided.

### BRIEF DESCRIPTION OF DRAWINGS

FIG. 1 shows a block diagram of the configuration of a system according to an exemplary embodiment of the present invention.

FIG. 2 shows a flowchart of a method according to an exemplary embodiment of the present invention.

FIG. 3 shows an example of a 3-dimensional image displayed on a screen.

FIG. 4 shows an example in a process according to an exemplary embodiment of the present invention.

FIG. 5 shows another example in a process according to an exemplary embodiment of the present invention.

### EMBODIMENTS OF THE INVENTION

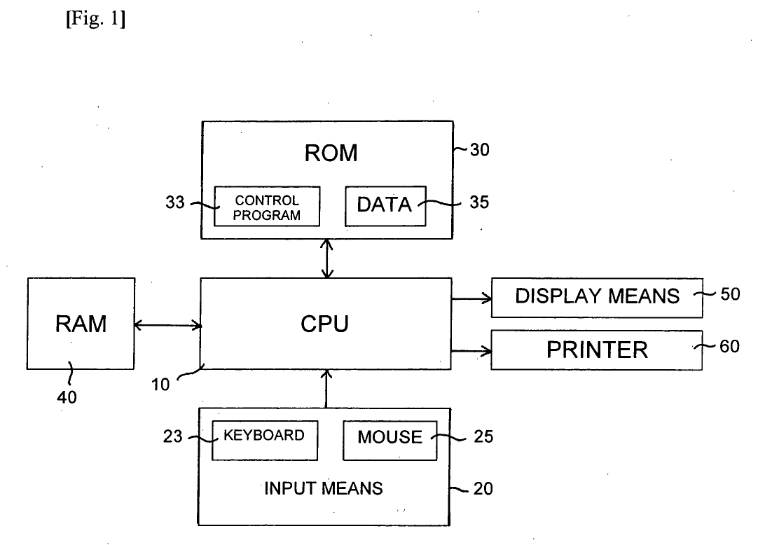

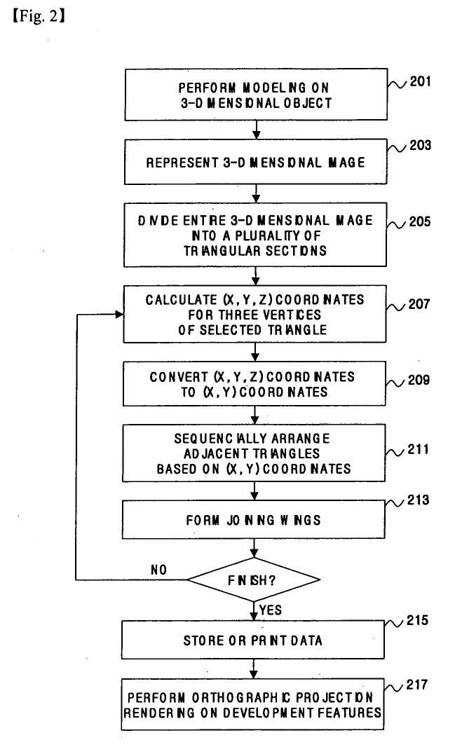

Hereinafter, the exemplary embodiments of the present invention will now be described in detail, referring to attached drawings. FIG. 1 shows the configuration of a development feature generating system according to an exemplary embodiment of the present invention. FIG. 2 shows a flowchart of a development feature generating method of this invention.

The configuration in FIG. 1 is merely an example of the technical ideas of this invention, so it should be noted that the technical scope of this invention is not limited to this example. The technical ideas of this invention can be embodied as an independent apparatus according to the intention of a person having ordinary skill in the art or a system for converting a 3-dimensional image to a 2-dimensional development feature by connecting to a server through networks in the form of a client-server system.

As shown in FIG. 1, the development feature generating system (50) according to this invention includes a 3-dimensional image generating module (51), a polygon image generating module (53), a first coordinate value converting module (55), a second coordinate value converting module (57), and a flat image representing module (59). A storage unit (20) including a CPU (10), a RAM, and a ROM, an input unit (30) including a keyboard and a mouse, an output unit (40) including a display means and a printer, etc. are elements that support the development feature generating system (50) of this embodiment.

The 3-dimensional image generating module (51) generates a 3-dimensional image by performing modeling on a 3-dimensional object for which a development feature is formed. To perform modeling on a 3-dimensional object means to convert a 3-dimensional practical object having a certain shape to a 3-dimensional image, and basically, it is necessary to lighten data and it is important to convey a practical image. The modeling technology of a 3-dimensional object is obvious to a person having ordinary skill in the art.

The polygon image generating module (53) generates a 3-dimensional polygon image by dividing the 3-dimensional image into a plurality of triangles. That is, it partitions the entire surface of the 3-dimensional image displayed by the output unit (40) into a plurality of triangular sections. The reason why the surface of the 3-dimensional image is partitioned into a plurality of triangles is that a totally flat coordinate value (x, y) for each piece is needed to form a 2-dimensional development feature.

The first coordinate value converting module (55) obtains the 3-dimensional coordinate values (x, y, z) for the three vertices of a first triangle among the plurality of triangles and converts the 3-dimensional coordinate value of each vertex to the 2-dimensional coordinate value (x, y) respectively.

The first coordinate value converting module (55) includes means for obtaining the lengths of the three sides of the first triangle from the 3-dimensional coordinate values (x, y, z) for the three vertices of the first triangle, means for converting the 3-dimensional coordinate value (x, y, z) for one of the three vertices of the first triangle to the 2-dimensional coordinate value (x, y), and means for obtaining the 2-dimensional coordinate values for the rest vertices from the lengths of the three sides of the first triangle and the 2-dimensional coordinate value (x, y) of the one of vertices.

Since each pixel's coordinates of the 3-dimensional image is determined by the 3-dimensional modeling, the vertices's coordinates A1 (x1, y1, z1), A2 (x2, y2, z2), A3 (x3, y3, z3) of the first triangle can be easily obtained. Here, A1, A2, and A3 represent the three vertices of a triangle placed in the 3-dimensional space. From the three vertices's coordinates obtained, the lengths of the three sides, i.e. A1A2, A2A3, and A3A1 of the triangle can be obtained. For example, the length of A1A2 can be obtained by the following equation 1:
A₁A₂=\sqrt{(x₁−-x₂)²+(y₁−y₂)²+(z₁−z₂)²}

A reference point, which is one (e.g. A1) of the three vertices of the first triangle, is taken and converted into the 2-dimensional coordinate value A1 (x1, y1). According to the fact that if the lengths of three sides of a triangle are the same and they are known, whether the triangle is located in the 3-dimensional or 2-dimensional space, then a unique triangle is determined, the 2-dimensional coordinate values A2 (x2, y2), A3 (x3, y3) for two of the three vertices of the first triangle can be obtained based on the lengths of the three sides of the first triangle with the reference to the determined 2-dimensional coordinate value A1 (x1, y1) for the rest one of the three vertices.

The second coordinate value converting module (55) includes means for obtaining the lengths of the three sides of the triangles adjacent to the triangle, of which the 2-dimensional coordinate values have been determined, from the 3-dimensional coordinate values (x, y, z) for the three vertices for the adjacent triangles and means for obtaining the 2-dimensional coordinate values for one of the three vertices from the 2-dimensional coordinate values for the rest two vertices in common with the triangle, of which the 2-dimensional coordinate values have been determined, and the lengths of the three sides of the adjacent triangles, and sequentially determines the 2-dimensional coordinate value for each vertex of the triangle adjacent to one of the three sides of the triangle, of which the 2-dimensional coordinate values have been determined for its three vertices. The 2-dimensional coordinate values for the two vertices in common with the triangle, of which the 2-dimensional coordinate values have been determined, are the same as the values already determined, and the 2-dimensional coordinate value for the rest one of the vertices can be calculated from the 2-dimensional coordinate values and the lengths of the three sides of the triangle.

The flat image representing module (58) represents the triangles as 2-dimensional images based on the 2-dimensional coordinate values (x, y) of the first triangle and the 2-dimensional coordinate values (x, y) of the adjacent triangles.

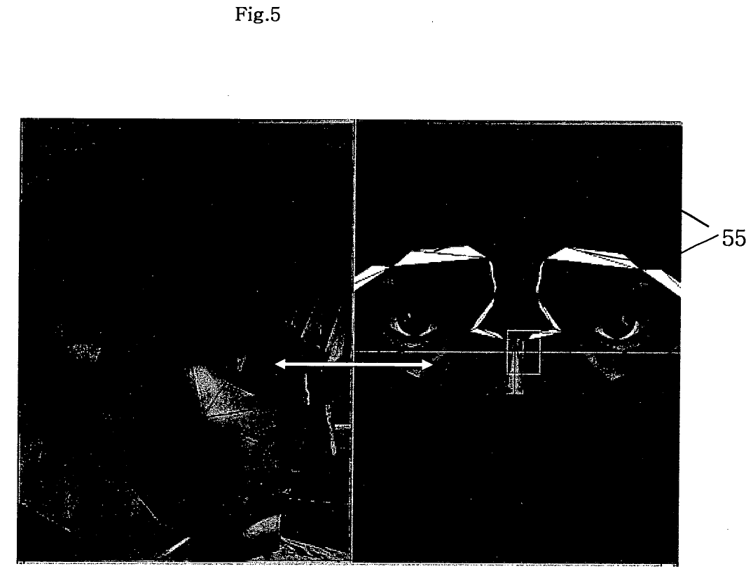

The joining wing forming module (59) forms joining wings (55 in FIG. 5) around each part developed in the 2-dimension. The joining wings are needed to make a 3-dimensional model by printing the 2-dimensional development features on a paper and inversely assembling them. The entire 3-dimensional image can be made as one development feature or divided into pieces and made as a 2-dimensional development feature for each piece.

In the case of making the entire 3-dimensional image as one development feature, a joining wing is formed extending from a part of the development feature, and in the case of dividing the 3-dimensional image into pieces to make a development feature, a number of joining wings needed for each piece are formed. Here, the piece means a configuration unit, which consists of a plurality of triangular sections. That is, a 3-dimensional image can be assembled by joining a plurality of pieces of 2-dimensional development features.

The development feature generating method according to the present invention shown in FIG. 2 includes a 3-dimensional image generating step of generating a 3-dimensional image by performing modeling on a 3-dimensional object [201], a polygon image generating step of generating a 3-dimensional polygon image by dividing the 3-dimensional image into a plurality of triangles [203], a first coordinate value converting step of obtaining 3-dimensional coordinate values (x, y; z) for the three vertices of a first triangle among the plurality of triangles and converting the 3-dimensional coordinate value for each vertex to the 2-dimensional coordinate value (x, y) [205], a first coordinate value converting step of sequentially determining the 2-dimensional coordinate values for the triangles adjacent to the three sides of the triangle, of which the 2-dimensional coordinate values have been determined for its three vertices [207], a flat image representing step of representing the triangles as a 2-dimensional image based on the 2-dimensional coordinate value (x, y) of the first triangle and the 2-dimensional coordinate values (x, y) of the adjacent triangles [208], and a joining wing forming step of forming joining wings around each piece 2-dimensionally developed [209].

The 3-dimensional image generating step [201] is the step of performing modeling on a 3-dimensional practical object, which is the subject of a development feature, and making it as a 3-dimensional image. The technique of performing modeling on a 3-dimensional practical object is publicly known as a 3D graphic program such as Maya, 3D Max, Light Wave, etc.

The polygon image generating step is the step of generating a 3-dimensional polygon image by dividing the 3-dimensional image into a plurality of triangles. That is, the 3-dimensional polygon image is generated by partitioning the entire surface of the 3-dimensional image into a plurality of triangular sections. The reason why the surface of the 3-dimensional image is partitioned into a plurality of triangles is that a totally flat coordinate value (x, y) for each piece is needed to form a 2-dimensional development feature.

The first coordinate value converting step [205] is the step of obtaining the 3-dimensional coordinate values (x, y, z) for the three vertices of a first triangle among the plurality of triangles and converting the 3-dimensional coordinate value of each vertex to the 2-dimensional coordinate value (x, y) respectively.

The first coordinate value converting step [205] includes a step of obtaining the lengths of the three sides of the first triangle from the 3-dimensional coordinate values (x, y, z) for the three vertices of the first triangle, a step of converting the 3-dimensional coordinate value (x, y, z) for one of the three vertices of the first triangle to the 2-dimensional coordinate value (x, y), and a step of obtaining the 2-dimensional coordinate values for the rest vertices from the lengths of the three sides of the first triangle and the 2-dimensional coordinate value (x, y) of the one of vertices.

Since each pixel's coordinates of the 3-dimensional image is determined by the 3-dimensional modeling, the vertices's coordinates A1 (x1, y1, z1), A2 (x2, y2, z2), A3 (x3, y3, z3) of the first triangle can be easily obtained. Here, A1, A2, and A3 represent the three vertices of a triangle placed in the 3-dimensional space. From the three vertices's coordinates obtained, the lengths of the three sides, i.e. A1A2, A2A3, and A3A1 of the triangle can be obtained. For example, the length of A1A2 can be obtained by the above equation 1.

A reference point, which is one (e.g. A1) of the three vertices of the first triangle, is taken and converted into the 2-dimensional coordinate value A1 (x1, y1). According to the fact that if the lengths of three sides of a triangle are the same and they are known, whether the triangle is located in the 3-dimensional or 2-dimensional space, then a unique triangle is determined, the 2-dimensional coordinate values A2 (x2, y2), A3 (x3, y3) for two of the three vertices of the first triangle can be obtained based on the lengths of the three sides of the first triangle with the reference to the determined 2-dimensional coordinate value A1 (x1, y1) for the rest one of the three vertices.

The second coordinate value converting step [207] includes a step of obtaining the lengths of the three sides of the triangles adjacent to the triangle, of which the 2-dimensional coordinate values have been determined, from the 3-dimensional coordinate values (x, y, z) for the three vertices for the adjacent triangles and a step of obtaining the 2-dimensional coordinate values for one of the three vertices from the 2-dimensional coordinate values for the rest two vertices in common with the triangle, of which the 2-dimensional coordinate values have been determined, and the lengths of the three sides of the adjacent triangles, and is to determine the 2-dimensional coordinate value for each vertex of the triangle adjacent to one of the three sides of the triangle, of which the 2-dimensional coordinate values have been determined for its three vertices. The 2-dimensional coordinate values for two vertices in common with the triangle, of which the 2-dimensional coordinate values have been determined, are the same as the values already determined, and the 2-dimensional coordinate value for the rest one of the vertices can be calculated from the 2-dimensional coordinate values and the lengths of the three sides of the triangle.

The flat image representing step [208] is the step of representing the triangles as 2-dimensional images based on the 2-dimensional coordinate values (x, y) of the first triangle and the 2-dimensional coordinate values (x, y) of the adjacent triangles.

The joining wing forming step [209] is the step of forming joining wings around each part developed in the 2-dimension. In the case of making the entire 3-dimensional image as one development feature, a joining wing is formed extending from a part of the development feature, and in the case of dividing the 3-dimensional image into pieces to make a development feature, a number of joining wings needed for each piece are formed.

Which part of the 3-dimensional image is made to pieces, how many triangular sections are included in one piece, which part of the piece the joining wings are formed on, etc. are determined totally by the intention of a user (e.g. how well a user can understand on paper crafts, know-how, preference, etc. thereon).

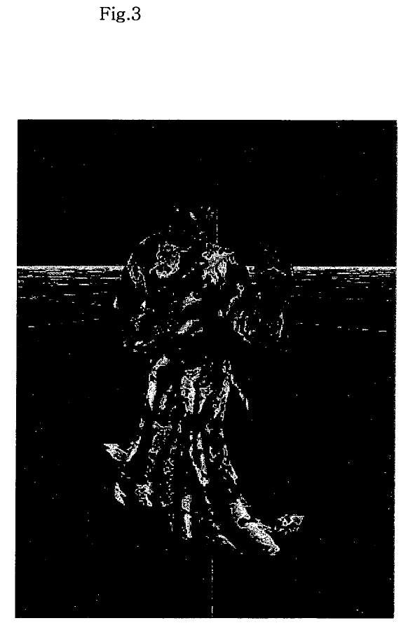

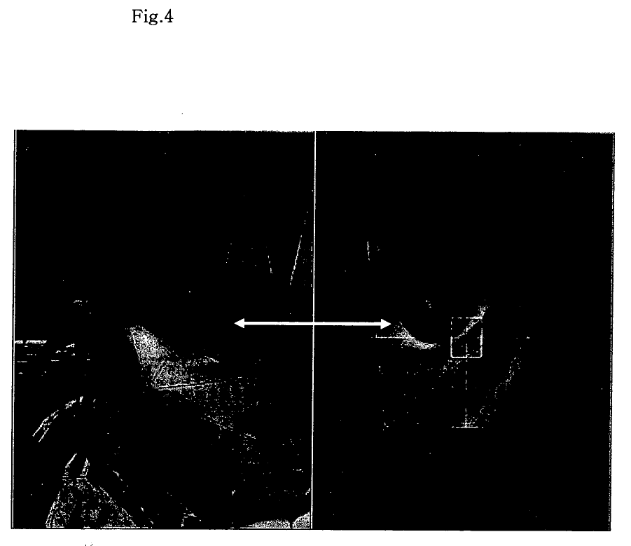

FIG. 3 shows an example of a 3-dimensional image displayed on a screen, FIG. 4 shows one of triangles selected and 2-dimensionally converted and another triangle besides the one 2-dimensionally converted and arranged with the 2-dimensional triangle, and FIG. 5 shows the periphery of both eyes of a man, on which the above processes have been repeatedly performed, formed as a 2-dimensional development feature.

Each piece 2-dimensionally developed can be stored in various file formats, and the development feature is printed on a paper by retrieving the stored data of the 2-dimensional development feature using a modeling program and performing rendering (printing, plotting, etc.) on the data in the orthographic projection manner.

Meanwhile, a computer readable medium such as a CD, floppy disk, hard disk, etc. on which a program for executing the development feature generating method of this invention is recorded is included in the technical scope of the present invention.

Although the present invention has been described by way of exemplary embodiments, it should be understood that those skilled in the art might make many changes and substitutions without departing from the spirit and the scope of the present invention which is defined only by the appended claims.

According to the present invention, the development feature generating system, the development feature generating method and the computer readable medium on which a program for executing the method is recorded provide a new technology of generating a 2-dimensional development feature for a 3-dimensional image, guaranteeing accuracy and economical efficiency by simple operation of a user.

According to the system and method of the present invention, animation or anything possible in the computer graphics can be modeled as a paper. That is obviously differentiated from the conventional paper-modeled development feature manually made, the manufacturing time of the development feature is shortened, and an irregularly shaped character with high quality, which has not been tried yet, can be manufactured as a paper model.

What is claimed is:

1. A development feature generating system for generating a development feature of a 3-dimensional object having a predetermined shape, comprising:
a 3-dimensional image generating module for generating a 3-dimensional image by modeling said 3-dimensional object;
a polygon image generating module for generating a 3-dimensional polygon image by dividing said 3-dimensional image into a plurality of triangles;
a first coordinate value converting module for obtaining 3-dimensional coordinate values (x, y, z) for three vertices of a first triangle among said plurality of triangles and converting said 3-dimensional coordinate value of each of said vertices into a 2-dimensional coordinate value (x, y);
a second coordinate value converting module for determining a 2-dimensional coordinate value for each vertex of a triangle adjacent to one of three sides of said triangle, in which said 2-dimensional coordinate values for three vertices thereof have been determined; and
a flat image representing module for representing said triangles as a 2-dimensional image based on said 2-dimensional coordinate values (x, y) of said first triangle and said 2-dimensional coordinate values (x, y) of said adjacent triangle.

2. A development feature generating system as claimed in claim 1, wherein said first coordinate value converting module comprises:
means for obtaining lengths of three sides of said first triangle from said 3-dimensional coordinate values (x, y, z) for said three vertices of said first triangle;
means for converting a 3-dimensional coordinate value (x, y, z) for one of said three vertices of said first triangle into a 2-dimensional coordinate value (x, y); and
means for obtaining 2-dimensional coordinate values for two of said three vertices of said first triangle from said lengths of said three sides of said first triangle and a 2-dimensional coordinate value (x, y) for rest one of said three vertices.

3. A development feature generating system as claimed in claim 1, wherein said second coordinate value converting module sets 2-dimensional coordinate values for two of three vertices of a triangle in common with a triangle, of which 2-dimensional coordinate values have been determined, to be equal to values already determined and calculates a 2-dimensional coordinate value for rest one of said three vertices from said 2-dimensional coordinate values and lengths of three sides of said triangle.

4. A development feature generating system as claimed in claim 3, wherein said second coordinate value converting module comprises:
means for obtaining said lengths of said three sides of said triangle adjacent to said triangle, of which said 2-dimensional coordinate values have been determined, from 3-dimensional coordinate values (x, y, z) for three vertices of said adjacent triangle; and
means for obtaining said 2-dimensional coordinate value for said rest one of said three vertices from said 2-dimensional coordinate values for said two of said three vertices in common with said triangle, of which said 2-dimensional coordinate values have been determined, and said lengths of said three sides of said adjacent triangle.

5. A development feature generating system as claimed in claim 1 further comprising a joining wing forming module for forming a joining wing around each piece 2-dimensionally developed.

6. A development feature generating method for generating a development feature of a 3-dimensional object having a predetermined shape, comprising:
a 3-dimensional image generating step of generating a 3-dimensional image by modeling said 3-dimensional object;
a polygon image generating step of generating a 3-dimensional polygon image by dividing said 3-dimensional image into a plurality of triangles;
a first coordinate value converting step of obtaining 3-dimensional coordinate values (x, y, z) for three vertices of a first triangle among said plurality of triangles and converting said 3-dimensional coordinate value of each of said vertices into a 2-dimensional coordinate value (x, y);
a second coordinate value converting step of determining a 2-dimensional coordinate value for each vertex of a triangle adjacent to one of three sides of said triangle, in which said 2-dimensional coordinate values for three vertices thereof have been determined; and
a flat image representing step of representing said triangles as a 2-dimensional image based on said 2-dimensional coordinate values (x, y) of said first triangle and said 2-dimensional coordinate values (x, y) of said adjacent triangle.

7. A development feature generating method as claimed in claim 6, wherein said first coordinate value converting step comprises the steps of:
obtaining lengths of three sides of said first triangle from said 3-dimensional coordinate values (x, y, z) for said three vertices of said first triangle;
converting a 3-dimensional coordinate value (x, y, z) for one of said three vertices of said first triangle into a 2-dimensional coordinate value (x, y); and
obtaining 2-dimensional coordinate values for two of said three vertices of said first triangle from said lengths of said three sides of said first triangle and a 2-dimensional coordinate value (x, y) for rest one of said three vertices.

8. A development feature generating method as claimed in claim 6, wherein during said second coordinate value converting step, 2-dimensional coordinate values for two of three vertices of a triangle in common with a triangle, of which 2-dimensional coordinate values have been determined, are set to be equal to values already determined, and a 2-dimensional coordinate value for rest one of said three vertices is calculated from said 2-dimensional coordinate values and lengths of three sides of said triangle.

9. A development feature generating method as claimed in claim 6, wherein said second coordinate value converting step comprises the steps of:
obtaining said lengths of said three sides of said triangle adjacent to said triangle, of which said 2-dimensional coordinate values have been determined, from 3-dimensional coordinate values (x, y, z) for three vertices of said adjacent triangle; and
obtaining said 2-dimensional coordinate value for said rest one of said three vertices from said 2-dimensional coordinate values for said two of said three vertices in common with said triangle, of which said 2-dimensional coordinate values have been determined, and said lengths of said three sides of said adjacent triangle.

10. A development feature generating method as claimed in claim 6, wherein an entire surface of said 3-dimensional image is divided into a plurality of pieces, and a 2-dimensional development feature is individually made for each of said plurality of pieces.

11. A development feature generating method as claimed in claim 6 further comprising a joining wing forming step of forming a joining wing around each piece 2-dimensionally developed.

12. A computer readable medium on which a program for executing said method of claim 6 is recorded.
